(19) United States
(12) Patent Application Publication
(10) Pub. No.: US 2023/0327140 A1
(43) Pub. Date: Oct. 12, 2023

(54) PRIMARY BATTERY

(71) Applicant: MURATA MANUFACTURING CO., LTD., Kyoto (JP)

(72) Inventors: Kohei WATANABE, Tokyo (JP); Minoru ONUMA, Tokyo (JP); Masaki SUGENO, Tokyo (JP)

(21) Appl. No.: 18/209,781

(22) Filed: Jun. 14, 2023

Related U.S. Application Data
(63) Continuation of application No. PCT/JP2021/033477, filed on Sep. 13, 2021.

(30) Foreign Application Priority Data
Dec. 25, 2020 (JP) 2020 217291
Jun. 23, 2021 (JP) 2021 104242

(51) Int. Cl. H01M 6/16; H01M 4/06; H01M 4/50; H01M 4/38; H01M 4/66

(52) U.S. Cl. CPC H01M 6/168; H01M 4/06; H01M 6/164; H01M 4/50; H01M 4/382; H01M 4/662; H01M 4/663; H01M 2300/0037

(57) ABSTRACT

A primary battery includes a positive electrode, a negative electrode, and an electrolytic solution. The positive electrode includes manganese dioxide. The negative electrode includes a lithium-based material. The electrolytic solution includes an alkali metal compound represented by Formula (1) and a dicarboxylic anhydride compound represented by Formula (2).

MeN(CₓF₂ₓ₊₁SO₂)(C_{y}F_{2y+1}SO₂) (1)
where:
Me is an alkali metal element; and
x and y are each an integer of 0 or greater.

W(—C(═O)—O—C(═O)—)_{z} (2)
where:
W is a benzene-based aromatic ring from which 2z-number of hydrogen atoms are eliminated; and
z is an integer of 2 or greater.

### CROSS REFERENCE TO RELATED APPLICATIONS

The present application is a continuation of PCT application no. PCT/JP2021/033477, filed on Sep. 13, 2021, which claims priority to Japanese patent application no. JP2021-104242, filed on Jun. 23, 2021, and Japanese patent application no. JP2020-217291, filed on Dec. 25, 2020, the entire contents of which are herein incorporated by reference.

### BACKGROUND

The present application relates to a primary battery.

A primary battery is being developed. A configuration of the primary battery has been considered in various ways.

Specifically, in order to improve a high-temperature storage characteristic, a positive electrode includes manganese oxide in a mixed crystal state, and a non-aqueous electrolytic solution includes LiClO₄ and LiN(SO₂R1)(SO₂R2). In order to suppress variation in open-circuit voltage, a positive electrode includes manganese oxide, and a non-aqueous electrolyte includes a salt that includes an inorganic anion including sulfur and fluorine. In order to suppress swelling upon high-temperature storage, a positive electrode includes manganese oxide, and a non-aqueous electrolytic solution includes LiClO₄ and LiN(FSO₂)₂. In order to suppress swelling in a high-temperature atmosphere, a non-aqueous electrolytic solution includes LiClO₄, LiN(CF₃SO₂)₂, and pyromellitic anhydride. In order to suppress swelling in a high-temperature atmosphere, a positive electrode includes manganese dioxide, and a non-aqueous electrolytic solution includes LiClO₄ and LiN(CF₃SO₂)₂.

### SUMMARY

The present application relates to a primary battery.

Although consideration has been given in various ways regarding a battery characteristic of a primary battery, a swelling characteristic of the primary battery is not sufficient yet. Accordingly, there is room for improvement in terms thereof.

It is therefore desirable to provide a primary battery that is able to achieve a superior swelling characteristic.

A primary battery according to an embodiment of the present technology includes a positive electrode, a negative electrode, and an electrolytic solution. The positive electrode includes manganese dioxide. The negative electrode includes a lithium-based material. The electrolytic solution includes an alkali metal compound represented by Formula (1) and a dicarboxylic anhydride compound represented by Formula (2).

MeN(CₓF₂ₓ₊₁SO₂)(C_{y}F_{2y+1}SO₂) (1)
where:
Me is an alkali metal element; and
x and y are each an integer of 0 or greater.

W(—C(═O)—O—C(═O)—)_{z} (2)
where:
W is a benzene-based aromatic ring from which 2z-number of hydrogen atoms are
eliminated; and
z is an integer of 2 or greater.

Here, the term “lithium-based material” is a generic term for a material including lithium as a constituent element. The lithium-based material may thus be a simple substance of lithium, a compound of lithium, an alloy of lithium, or a mixture of two or more thereof.

The “benzene-based aromatic ring” is a ring including one or more benzene rings. Note that a ring including two or more benzene rings is a condensed ring of the two or more benzene rings.

According to the primary battery of an embodiment of the present technology, the positive electrode includes manganese dioxide, the negative electrode includes the lithium-based material, and the electrolytic solution includes the alkali metal compound and the dicarboxylic anhydride compound. This makes it possible to achieve a superior swelling characteristic.

Note that effects of the present technology are not necessarily limited to those described herein and may include any of a series of suitable effects in relation to the present technology.

### BRIEF DESCRIPTION OF THE FIGURES

FIG. 1 is a sectional view of a configuration of a primary battery according to an embodiment of the present technology.

FIG. 2 is a sectional view of a configuration of a primary battery according to an embodiment of the present technology.

FIG. 3 is a sectional view of a configuration of a primary battery according to an embodiment of the present technology.

FIG. 4 is a block diagram illustrating a configuration of an application example of the primary battery, which is a smart meter.

### DETAILED DESCRIPTION

One or more embodiments of the present technology are described below in further detail including with reference to the drawings.

A description is given first of a primary battery according to an embodiment of the present technology.

The primary battery to be described here has a flat three-dimensional shape. That is, the primary battery described below is a primary battery of a so-called coin-type having a three-dimensional shape with an outer diameter greater than a height.

FIG. 1 illustrates a sectional configuration of the primary battery. The primary battery includes a battery can 10, a gasket 20, a positive electrode 30, a negative electrode 40, a separator 50, an electrically conductive layer 60, and an electrolytic solution, as illustrated in FIG. 1. The electrolytic solution is a liquid electrolyte. Note that FIG. 1 omits the illustration of the electrolytic solution.

The “outer diameter” described above is a maximum dimension of the primary battery in a horizontal direction in FIG. 1. The “height” described above is a maximum dimension of the primary battery in a vertical direction in FIG. 1.

The battery can 10 is a containing member that contains components including, without limitation, the positive electrode 30, the negative electrode 40, and the separator 50. The battery can 10 includes a pair of bowl-like shaped members each having an open end part and a closed end part. The pair of bowl-like shaped members are a positive electrode container 11 and a negative electrode container 12.

The positive electrode container 11 is a positive electrode containing member that contains the positive electrode 30. The positive electrode container 11 has a substantially cylindrical three-dimensional shape that includes a bottom part and a sidewall part. The positive electrode container 11 has an opening 11K that is the open end part. Note that, because the positive electrode container 11 is indirectly coupled to the positive electrode 30 via the electrically conductive layer 60, the positive electrode container 11 also serves as a current collector of the positive electrode 30 and an external coupling terminal of the positive electrode 30. The external coupling terminal of the positive electrode 30 is a so-called positive electrode terminal.

The positive electrode container 11 includes one or more of electrically conductive materials including, without limitation, a metal material. Specific examples of the metal material include aluminum and stainless steel. The stainless steel is not particularly limited in kind, and specific examples thereof include SUS316, SUS430, and SUS444. Note that the positive electrode container 11 may be single-layered or multi-layered. The positive electrode container 11 may have a plated surface.

The negative electrode container 12 is a negative electrode containing member that contains the negative electrode 40. As with the positive electrode container 11, the negative electrode container 12 has a substantially cylindrical three-dimensional shape that includes a bottom part and a sidewall part. As with the positive electrode container 11, the negative electrode container 12 has an opening 12K that is the open end part. Note that, because the negative electrode container 12 is coupled to the negative electrode 40, the negative electrode container 12 also serves as a current collector of the negative electrode 40 and an external coupling terminal of the negative electrode 40. The external coupling terminal of the negative electrode 40 is a so-called negative electrode terminal.

Here, the opening 12K of the negative electrode container 12 has an inner diameter less than an inner diameter of the opening 11K of the positive electrode container 11. Accordingly, in a state where the positive electrode container 11 and the negative electrode container 12 are disposed with the openings 11K and 12K facing each other, the negative electrode container 12 is placed inside the positive electrode container 11.

The negative electrode container 12 includes one or more of electrically conductive materials including, without limitation, a metal material. Details of the metal material are similar to those of the positive electrode container 11.

Here, the positive electrode container 11 and the negative electrode container 12 are crimped to each other with the gasket 20 interposed therebetween in a state where the negative electrode container 12 is disposed inside the positive electrode container 11. In this case, an end part of the negative electrode container 12 on a side opposed to the positive electrode container 11 extends toward the positive electrode container 11 and is then folded outward to extend away from the positive electrode container 11. The battery can 10 is thus sealed with the components including, without limitation, the positive electrode 30, the negative electrode 40, and the separator 50 contained therein.

The gasket 20 is interposed between the positive electrode container 11 and the negative electrode container 12. The gasket 20 is a ring-shaped sealing member that seals a space between the positive electrode container 11 and the negative electrode container 12. The gasket 20 includes one or more of polymer compounds. Specific examples of polymers include polypropylene (PP), polybutylene terephthalate (PBT), and nylon. Specific examples of the polymer compounds include a fluororesin such as perfluoroalkoxy alkane (PFA) or polytetrafluoroethylene (PTFE). Specific examples of the polymer compounds also include polyphenylene ether (PPE), polysulfone (PSF), polyarylate (PAR), polyethersulfone (PES), polyphenylene sulfide (PPS), polyetheretherketone (PEEK), and polyetherimide (PEI). In particular, any of PPS, PBT, and PEI is preferable in consideration of sealing performance in a high-temperature environment and mass productivity (moldability) of the gasket 20, and PPS having superior moisture-proof performance is particularly preferable.

The positive electrode 30 is a coin-shaped pellet. That is, the positive electrode 30 is a positive electrode mixture molded into a coin-shaped pellet. The positive electrode 30 includes a positive electrode active material. The positive electrode 30 may further include materials including, without limitation, a positive electrode binder and a positive electrode conductor.

The positive electrode active material includes manganese dioxide (MnO₂). A reason for this is that an operating voltage increases, as compared with a case where the positive electrode active material includes a material such as iron sulfide or copper oxide. Another reason for this is that a load characteristic improves, as compared with a primary battery that operates within a substantially similar voltage range, specifically, a primary battery in which a positive electrode active material includes a material such as graphite fluoride. Note that the positive electrode active material may include two or more kinds of manganese dioxide that differ in crystallinity from each other.

Manganese dioxide is not particularly limited in kind, and specific examples thereof include α-MnO₂, β-MnO₂, γ-MnO₂, and ε-MnO₂. In particular, β-MnO₂ is preferable. A reason for this is that a highest theoretical capacity is obtainable. Note that manganese dioxide may include an impurity such as Mn₂O₃ or Mn₃O₄.

A specific surface area of particles of manganese dioxide is not particularly limited, and is preferably within a range from 10 m²/g to 50 m²/g both inclusive, in particular. A reason for this is that this results in an appropriately large reactive area of the particles of manganese dioxide, which improves a heavy load characteristic, and suppresses a decomposition reaction of the electrolytic solution in a high-temperature storage environment. Accordingly, the specific surface area within the range from 10 m²/g to 50 m²/g both inclusive is effective, as described above, in terms of achieving both the heavy load characteristic and a high-temperature storage characteristic.

The positive electrode binder includes one or more of polymer compounds. Specific examples of the polymer compounds include a fluorine-based polymer compound such as polytetrafluoroethylene or polyvinylidene difluoride. The positive electrode conductor includes one or more of electrically conductive materials including, without limitation, a carbon material. Specific examples of the carbon material include carbon black, graphite, and graphene, and may also include a carbon fiber such as a vapor-grown carbon fiber (VGCF).

In particular, the positive electrode 30 preferably includes the positive electrode binder. A reason for this is that moldability of the positive electrode 30 improves. A content of the positive electrode binder in the positive electrode 30 is not particularly limited, and is preferably greater than or equal to 1.4 mass % and less than 10 mass %, in particular. A reason for this is that a characteristic such as superior mechanical strength is obtainable, while a decrease in discharge capacity is suppressed.

In addition, the positive electrode 30 preferably includes the positive electrode conductor. A reason for this is that electrical conductivity of the positive electrode 30 improves. In a case where the positive electrode 30 includes the positive electrode conductor (the carbon material), a mixture ratio (a weight ratio) between the positive electrode active material (manganese dioxide) and the positive electrode conductor is not particularly limited, and is preferably within a range from 90:10 to 97:3 both inclusive, in particular. A reason for this is that a characteristic such as a superior pulse discharge characteristic on the order of several tens of milliamperes is obtainable, while an electrical characteristic such as a battery capacity is secured.

The negative electrode 40 includes one or more of lithium-based materials. A reason for this is that a weight energy density increases, which allows for fabrication of a primary battery, more specifically, a lithium primary battery having a high capacity. Note that, in order to improve a large-current characteristic of the primary battery in a low-temperature environment, it is preferable to use two or more of lithium-based materials.

The term “lithium-based material” is a generic term for a material including lithium as a constituent element, as described above. The lithium-based material may thus be a simple substance of lithium, a compound of lithium, an alloy of lithium, or a mixture of two or more thereof. Specific examples of the alloy of lithium include a lithium-aluminum alloy, a lithium-tin alloy, a lithium-silicon alloy, and a lithium-nickel alloy. Specific examples of the compound of lithium include LiC₆.

Note that, in a case where the lithium-based material is a compound of lithium, the negative electrode 40 may be a coin-shaped pellet, that is, a negative electrode mixture molded into a coin-shaped pellet. In this case, the negative electrode 40 may include a negative electrode binder. Details of the negative electrode binder are similar to those of the positive electrode binder.

The separator 50 is interposed between the positive electrode 30 and the negative electrode 40. The positive electrode 30 and the negative electrode 40 are thus opposed to each other with the separator 50 interposed therebetween.

The separator 50 includes a porous film, a nonwoven fabric, or both. The porous film and the nonwoven fabric each include one or more of polymer compounds including, without limitation, polyethylene, polypropylene, a methylpentene polymer, polybutylene terephthalate, and polyphenylene sulfide. Note that the separator 50 may include one or more of inorganic materials including, without limitation, a glass fiber and ceramic.

The separator 50 may be single-layered or multi-layered. The separator 50 may have a surface coated with a material such as a surface active agent.

In particular, the separator 50 is preferably the nonwoven fabric. A reason for this is that a property of the separator 50 absorbing the electrolytic solution improves. Note that it is preferable that the nonwoven fabric have a basis weight within a range from 10 g/m² to 100 g/m² both inclusive, and that the nonwoven fabric have a thickness within a range from 80 μm to 500 μm both inclusive. A reason for this is that occurrence of an internal short circuit is suppressed in the primary battery after high-temperature storage, while the property of the separator 50 absorbing the electrolytic solution is secured.

The electrically conductive layer 60 is interposed between the positive electrode container 11 and the positive electrode 30. A reason for this is that a characteristic such as the pulse discharge characteristic on the order of several tens of milliamperes improves.

The electrically conductive layer 60 includes one or more kinds of electrically conductive materials in a powder form (electrically conductive particles). Specific examples of the electrically conductive materials include silver and a carbon material.

The positive electrode 30, the negative electrode 40, and the separator 50 are each impregnated with the electrolytic solution. The electrolytic solution includes an alkali metal compound represented by Formula (1) and a dicarboxylic anhydride compound represented by Formula (2). Note that, inside the battery can 10, the electrolytic solution may further be present in a space around components including, without limitation, the positive electrode 30, the negative electrode 40, and the separator 50.

MeN(CₓF₂ₓ₊₁SO₂)(C_{y}F_{2y+1}SO₂) (1)
where:
Me is an alkali metal element; and
x and y are each an integer of 0 or greater.

W(—C(═O)—O—C(═O)—)_{z} (2)
where:
W is a benzene-based aromatic ring from which 2z-number of hydrogen atoms are eliminated; and
z is an integer of 2 or greater.

A reason why the electrolytic solution includes the alkali metal compound and the dicarboxylic anhydride compound together is that this suppresses both a decomposition reaction of a solvent and the decomposition reaction of the electrolytic solution, even if the positive electrode 30 includes manganese dioxide. Details of the reason described here are to be described later.

As indicated in Formula (1), the alkali metal compound is a compound (an alkali metal imide salt) including a cation (Me) that is an alkali metal ion, and an imide anion (N(CₓF₂ₓ₊₁SO₂)(C_{y}F_{2y+1}SO₂)) having two fluorine- and sulfur-containing groups. Note that only one alkali metal compound may be used, or two or more alkali metal compounds may be used.

The alkali metal element (Me) is not particularly limited in kind as long as the alkali metal element belongs to group 1 in the long period periodic table of elements, and specific examples thereof include lithium, sodium, and potassium. In particular, the alkali metal element is preferably lithium. A reason for this is that, because the negative electrode includes the lithium-based material, the alkali metal compound also serves as an electrolyte salt, which results in an increase in the battery capacity.

Note that x and y are each not particularly limited as long as x and y are each an integer of 0 or greater, as described above. A value of x and a value of y may be the same as or different from each other.

Specific examples of the alkali metal compound include lithium bis(fluorosulfonyl)imide (LiN(FSO₂)₂), lithium bis(trifluoromethanesulfonyl)imide (LiN(CF₃SO₂)₂), and lithium bis(pentafluoroethanesulfonyl)imide (LiN(C₂F₅SO₂)₂). A reason for this is that the decomposition reaction of the electrolytic solution is sufficiently suppressed on a surface of the positive electrode 30, even if the positive electrode 30 includes manganese dioxide.

For the purpose of understanding, x and y are both 0 in lithium bis(fluorosulfonyl)imide, x and y are both 1 in lithium bis(trifluoromethanesulfonyl)imide, and x and y are both 2 in lithium bis(pentafluoroethanesulfonyl)imide.

A content of the alkali metal compound in the electrolytic solution is not particularly limited, and is preferably within a range from 1.0 wt % to 22.0 wt % both inclusive, in particular. A reason for this is that the decomposition reaction of the electrolytic solution is further suppressed on the surface of the positive electrode 30.

As indicated in Formula (2), the dicarboxylic anhydride compound is a compound including a benzene-based aromatic ring (W) from which 2z-number of hydrogen atoms are eliminated, and z-number of dicarboxylic anhydride groups (—C(═O)—O—C(═O)—). Note that only one dicarboxylic anhydride compound may be used, or two or more dicarboxylic anhydride compounds may be used.

That is, the dicarboxylic anhydride compound is a compound in which z-number of dicarboxylic anhydride compound groups that are divalent are introduced into the benzene-based aromatic ring. In other words, the dicarboxylic anhydride compound is a compound in which 2z-number of hydrogen atoms of the benzene-based aromatic ring are substituted with z-number of dicarboxylic anhydride groups.

The “benzene-based aromatic ring” is a ring including one or more benzene rings, as described above. Note that a ring including two or more benzene rings is a condensed ring of the two or more benzene rings. A ring including one benzene ring is thus a so-called benzene ring. Specific examples of the ring including two or more benzene rings include a naphthalene ring, an anthracene ring, and a phenanthrene ring.

A reason why the dicarboxylic anhydride compound includes the benzene-based aromatic ring is that this makes it easier for the dicarboxylic anhydride compound to be adsorbed on the positive electrode 30, which allows for easier formation of a film that serve as a great steric hindrance. This suppresses the decomposition reaction of the electrolytic solution due to a reaction with the positive electrode 30, even in a high-temperature environment. Note that, in a case where another dicarboxylic anhydride compound including no benzene-based aromatic ring is used, it becomes difficult for the other dicarboxylic anhydride compound to be adsorbed on the positive electrode 30. As a result, the decomposition reaction of the electrolytic solution due to the reaction with the positive electrode 30 is not suppressed. The other dicarboxylic anhydride compound described here will be described in detail later.

Two carbon atoms in the benzene-based aromatic ring to which the dicarboxylic anhydride group is bonded may be two carbon atoms adjacent to each other, or two carbon atoms separated from each other with one or more carbon atoms interposed therebetween.

Note that z is not particularly limited as long as z is an integer of 2 or greater, as described above. Accordingly, the number of dicarboxylic anhydride groups is not one, but two or more. A reason for this is that the decomposition reaction of the electrolytic solution is not suppressed on the surface of the positive electrode 30 including manganese dioxide in a case where the number of dicarboxylic anhydride groups is only one, whereas the decomposition reaction of the electrolytic solution is suppressed on the surface of the positive electrode 30 including manganese dioxide in a case where the number of dicarboxylic anhydride groups is two or more. Note that, in a case where another dicarboxylic anhydride compound in which the number of dicarboxylic anhydride groups is one is used, the other dicarboxylic anhydride compound reacts with the negative electrode 40 upon aging of the primary battery, which causes the other dicarboxylic anhydride compound to be mostly decomposed. As a result, the decomposition reaction of the electrolytic solution is not suppressed as described above.

Specific examples of the dicarboxylic anhydride compound include pyromellitic anhydride and mellitic anhydride. A reason for this is that an increase in electric resistance of the positive electrode 30 is suppressed, while the decomposition reaction of the electrolytic solution is suppressed on the surface of the positive electrode 30.

For the purpose of understanding, the benzene-based aromatic ring is a benzene ring and the number of dicarboxylic anhydride groups is two in pyromellitic anhydride, and the benzene-based aromatic ring is a benzene ring and the number of dicarboxylic anhydride groups is three in mellitic anhydride.

A content of the dicarboxylic anhydride compound in the electrolytic solution is not particularly limited, and is preferably within a range from 0.1 wt % to 5.0 wt % both inclusive, in particular. A reason for this is that an increase in the electric resistance of the positive electrode 30 is further suppressed.

The electrolytic solution may further include one or more of other materials including, without limitation, a solvent and an electrolyte salt.

The solvent includes one or more of non-aqueous solvents (organic solvents), and the electrolytic solution including the non-aqueous solvent(s) is a so-called non-aqueous electrolytic solution. The non-aqueous solvent includes a high boiling solvent, a low boiling solvent, or both.

The high boiling solvent is a solvent having a higher boiling point than the low boiling solvent, and specific examples thereof include a cyclic carbonic acid ester. Specific examples of the cyclic carbonic acid ester include ethylene carbonate, propylene carbonate, and butylene carbonate. Specific examples of the cyclic carbonic acid ester may also include vinylene carbonate having an unsaturated bond (a carbon-carbon double bond).

The low boiling solvent is a solvent having a lower boiling point than the high boiling solvent, and specific examples thereof include an ether compound. Specific examples of the ether compound include 1,2-dimethoxyethane (monoglyme), diglyme, triglyme, tetraglyme, methoxyethoxyethane, 1,2-diethoxyethane, tetrahydrofuran, γ-butyrolactone, and 1,3-dioxolane.

In particular, the non-aqueous solvent preferably includes the cyclic carbonic acid ester and a dialkoxyalkane. In this case, it is preferable that the cyclic carbonic acid ester include propylene carbonate, butylene carbonate, or both described above, and that the dialkoxyalkane include 1,2-dimethoxyethane, 1,2-diethoxyethane, or both described above.

A mixture ratio between the cyclic carbonic acid ester and the dialkoxyalkane is preferably within a range from 0.10 to 7.00 both inclusive. The mixture ratio is a ratio of a content of the dialkoxyalkane in the electrolytic solution to a content of the cyclic carbonic acid ester in the electrolytic solution. The mixture ratio is thus calculated based on the following calculation expression: mixture ratio=content of dialkoxyalkane in electrolytic solution/content of cyclic carbonic acid ester in electrolytic solution.

A reason why the mixture ratio is within the above-described range is that the content of the dialkoxyalkane is made appropriate with respect to the content of the cyclic carbonic acid ester, which further suppresses an increase in the electric resistance of the positive electrode 30, while securing the electrical characteristic such as the battery capacity. Another reason is that leakage of the electrolytic solution is also suppressed.

The electrolyte salt includes one or more of light metal salts including, without limitation, a lithium salt. Specific examples of the lithium salt include lower lithium carboxylate, lithium halide, lithium nitrate, lithium perchlorate, lithium hexafluorophosphate, lithium fluoroborate, lithium chloroborate, fluorine-containing lithium alkylsulfonylimide, lithium hexafluoroarsenate, lithium hexafluoroantimonate, lithium tetraphenylborate, lithium bis(oxalato)borate, and LiCₙF₂ₙ₊₁SO₃ (n≥1).

In particular, the electrolyte salt preferably includes lithium perchlorate. A reason for this is that lithium perchlorate is inexpensive and allows characteristics including, without limitation, superior electrical conductivity and superior long-term reliability to be obtained.

A content of the electrolyte salt in the electrolytic solution is not particularly limited, and is preferably less than or equal to 12 wt %, more preferably within a range from 1 wt % to 12 wt % both inclusive, in particular. A reason for this is that an increase in the electric resistance of the positive electrode 30 is further suppressed, while the electrical characteristic such as the battery capacity is secured.

A weight of the electrolytic solution is not particularly limited, and is preferably within a predetermined range with respect to a weight of the positive electrode 30, in particular. Specifically, a ratio W3/W4 between a weight W3 of the electrolytic solution and a weight W4 of the positive electrode 30 is preferably within a range from 0.18 to 0.33 both inclusive. The ratio W3/W4 is a ratio of the weight W3 to the weight W4, and is thus calculated based on the following calculation expression: ratio W3/W4=weight W3/weight W4. Note that a value of the ratio W3/W4 is rounded off to two decimal places.

A reason why the ratio W3/W4 is within the above-described range is that an amount of the electrolytic solution is made appropriate with respect to the weight of the positive electrode 30, which increases the discharge capacity.

A procedure of calculating the ratio W3/W4 is as described below. Note that, in a case of calculating the ratio W3/W4 using the primary battery, a primary battery having an open-circuit voltage (OCV) of greater than or equal to 3.08 V is used. A reason for this is that, although the amount of the electrolytic solution decreases along with use of the primary battery, it is possible to calculate the ratio W3/W4 stably and reproducibly almost without influence of a usage history of the primary battery if the OCV is greater than or equal to 3.08 V, because the amount of the electrolytic solution has not excessively decreased in the primary battery. Another reason for this is that the discharge capacity increases if the OCV is greater than or equal to 3.08 V.

First, a weight WA of the primary battery is measured. As described above, the primary battery includes, together with the electrolytic solution, a series of components excluding the electrolytic solution and including, without limitation, the positive electrode 30, the negative electrode 40, and the separator 50. Accordingly, the weight WA is a sum of respective weights of the electrolytic solution and the series of components.

Thereafter, the primary battery is disassembled to thereby collect the series of components. Thereafter, the components are washed with a washing solvent to thereby wash away the electrolytic solution attached to the components, following which the components are dried. The washing solvent is not particularly limited in kind, and is specifically an organic solvent such as dimethyl carbonate.

Thereafter, a weight WB of the dried series of components is measured. In this case, weights of the components are measured to thereby obtain a sum of the weights of the components as the weight WB. The weight W4 of the positive electrode 30 which is one of the components is also measured thereby.

Lastly, the weight WB is subtracted from the weight WA to thereby calculate the weight W3 (=WA−WB) of the electrolytic solution, following which the ratio W3/W4 is calculated based on respective calculation results of the weights W3 and W4.

The primary battery is manufactured by the following procedure according to an embodiment.

First, the positive electrode active material, the positive electrode binder, and the positive electrode conductor are mixed with each other to thereby obtain a positive electrode mixture. Thereafter, the positive electrode mixture and a solvent are mixed with each other to thereby prepare a positive electrode mixture dispersion. The solvent may be an aqueous solvent or an organic solvent. Thereafter, the positive electrode mixture dispersion is heated to thereby vaporize the solvent in the positive electrode mixture dispersion. Lastly, the dried positive electrode mixture is pressure-molded by means of a tablet press. In this manner, the positive electrode 30 which is a molded body of the positive electrode mixture is fabricated.

As the negative electrode 40, a lithium metal foil which is a simple substance of lithium is prepared.

The electrolyte salt is put into the solvent, following which the alkali metal compound and the dicarboxylic anhydride compound are added to the solvent. The electrolyte salt, the alkali metal compound, and the dicarboxylic anhydride compound are thereby each dispersed or dissolved in the solvent. As a result, the electrolytic solution is prepared.

A paste including the electrically conductive material is applied on an inner bottom surface of the positive electrode container 11 to thereby form the electrically conductive layer 60. A silver paste is used in a case of using silver as the electrically conductive material. A carbon paste is used in a case of using a carbon material as the electrically conductive material.

First, the positive electrode 30 is placed inside the positive electrode container 11 with the electrically conductive layer 60 formed on the inner bottom surface, and the negative electrode 40 is placed inside the negative electrode container 12. The positive electrode 30 is thereby indirectly coupled to the positive electrode container 11 via the electrically conductive layer 60.

Thereafter, the positive electrode 30 placed inside the positive electrode container 11 and the negative electrode 40 placed inside the negative electrode container 12 are stacked on each other, with the separator 50 impregnated with the electrolytic solution interposed therebetween. In this case, the negative electrode container 12 is placed inside the positive electrode container 11 with the gasket 20 interposed therebetween. The positive electrode 30 and the negative electrode 40 are thereby each impregnated with a portion of the electrolytic solution.

Lastly, the positive electrode container 11 and the negative electrode container 12 are crimped to each other with the gasket 20 interposed therebetween to form the battery can 10. This seals the components including, without limitation, the positive electrode 30, the negative electrode 40, and the separator 50 in the battery can 10. The primary battery is thus completed.

According to the primary battery, the positive electrode 30 includes manganese dioxide, the negative electrode 40 includes the lithium-based material, and the electrolytic solution includes the alkali metal compound indicated in Formula (1) and the dicarboxylic anhydride compound indicated in Formula (2). This makes it possible to achieve a superior swelling characteristic for the following reasons.

If the positive electrode 30 includes manganese dioxide, the operating voltage increases and the load characteristic improves as described above, but moisture such as water of crystallization or water of adhesion included in the manganese dioxide causes the solvent in the electrolytic solution to be hydrolyzed easily. Thus, gas is generated easily due to the hydrolysis of the solvent, which causes the primary battery to swell easily. This tendency is significant, in particular, in a case where the solvent includes the cyclic carbonic acid ester and the primary battery is used and stored in a high-temperature environment, and carbonic acid gas is generated easily due to the hydrolysis of the cyclic carbonic acid ester.

In view of this, if the electrolytic solution includes the dicarboxylic anhydride compound, the dicarboxylic anhydride compound captures moisture, which prevents the solvent in the electrolytic solution from being hydrolyzed easily. Thus, gas is prevented from being generated easily due to the hydrolysis of the solvent, which prevents the primary battery from swelling easily.

The function of suppressing the hydrolysis of the solvent described here is exerted by the dicarboxylic anhydride compound satisfying the condition indicated in Formula (2), but is not exerted by another dicarboxylic anhydride compound not satisfying the condition indicated in Formula (2). The “other dicarboxylic anhydride compound” is a compound not satisfying the condition indicated in Formula (2), and specific examples thereof include glutaric anhydride, phthalic anhydride, malonic anhydride, and maleic anhydride. The other dicarboxylic anhydride compounds described here as examples include no benzene-based aromatic ring or include only one dicarboxylic anhydride group, thus being different from the dicarboxylic anhydride compound indicated in Formula (2).

Moreover, because the electrolytic solution includes the alkali metal compound, the alkali metal compound is adsorbed on the surface of the positive electrode 30, which results in formation of an electrochemically stable film on the surface of the positive electrode 30. Thus, the decomposition reaction of the electrolytic solution is suppressed on the surface of the positive electrode 30, which prevents gas from being generated easily by the decomposition reaction of the electrolytic solution.

Based upon the foregoing, the alkali metal compound and the dicarboxylic anhydride compound work synergistically to suppress generation of gas due to the hydrolysis of the solvent, and also suppress generation of gas due to the decomposition reaction of the electrolytic solution. This makes it possible to achieve a superior swelling characteristic.

In particular, the alkali metal element (Me) in Formula (1) may include lithium. This improves the electrical characteristic such as the battery capacity, while securing the swelling characteristic. Accordingly, it is possible to achieve higher effects.

Further, the alkali metal compound may include one or more of lithium bis(fluorosulfonyl)imide, lithium bis(trifluoromethanesulfonyl)imide, or lithium bis(pentafluoroethanesulfonyl)imide. In such a case, even if the positive electrode 30 includes manganese dioxide, the decomposition reaction of the electrolytic solution is sufficiently suppressed on the surface of the positive electrode 30. Accordingly, it is possible to achieve higher effects.

Further, the dicarboxylic anhydride compound may include pyromellitic anhydride, mellitic anhydride, or both. This prevents the electric resistance of the positive electrode 30 from increasing easily, while suppressing the decomposition reaction of the electrolytic solution on the surface of the positive electrode 30. This makes it possible to achieve not only a superior swelling characteristic, but also a superior electric resistance characteristic. Accordingly, it is possible to achieve higher effects.

Further, the content of the alkali metal compound in the electrolytic solution may be within the range from 1.0 wt % to 22.0 wt % both inclusive. This further suppresses the decomposition reaction of the electrolytic solution on the surface of the positive electrode 30. Accordingly, it is possible to achieve higher effects.

Further, the content of the dicarboxylic anhydride compound in the electrolytic solution may be within the range from 0.1 wt % to 5.0 wt % both inclusive. This further suppresses an increase in the electric resistance of the positive electrode 30. This makes it possible to achieve not only a superior swelling characteristic, but also a superior electric resistance characteristic. Accordingly, it is possible to achieve higher effects.

Further, the electrolytic solution may include the cyclic carbonic acid ester such as propylene carbonate and the dialkoxyalkane such as 1,2-dimethoxyethane, and the mixture ratio may be within the range from 0.10 to 7.00 both inclusive. This further prevents the electric resistance of the positive electrode 30 from increasing easily, while securing the electrical characteristic such as the battery capacity. Accordingly, it is possible to achieve higher effects.

Further, the electrolytic solution may include lithium perchlorate as the electrolyte salt, and the content of the electrolyte salt in the electrolytic solution may be within the range from 1 wt % to 12 wt % both inclusive. This further prevents the electric resistance of the positive electrode 30 from increasing easily, while securing the electrical characteristic such as the battery capacity. Accordingly, it is possible to achieve higher effects.

Further, the ratio W3/W4 may be within the range from 0.18 to 0.33 both inclusive. This increases the discharge capacity. Accordingly, it is possible to achieve higher effects.

The configuration of the primary battery described above is appropriately modifiable including as described below according to an embodiment. Note that any two or more of the following series of modifications may be combined with each other.

In FIG. 1, the primary battery includes the electrically conductive layer 60, and the positive electrode 30 is thus indirectly coupled to the positive electrode container 11 via the electrically conductive layer 60. However, the primary battery may include no electrically conductive layer 60, and the positive electrode 30 may thus be directly coupled to the positive electrode container 11. In this case also, the positive electrode 30 is electrically coupled to the positive electrode container 11. Accordingly, it is possible to achieve similar effects.

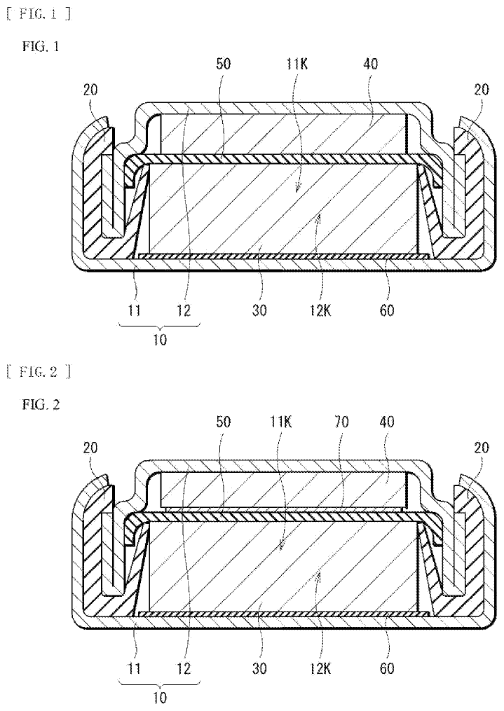

In FIG. 1, the negative electrode 40 is directly adjacent to the separator 50. However, as illustrated in FIG. 2 corresponding to FIG. 1, the primary battery may further include a powder layer 70, and the negative electrode 40 may thus be indirectly adjacent to the separator 50 with the powder layer 70 interposed therebetween.

The powder layer 70 is disposed between the negative electrode 40 and the separator 50, and is adjacent to each of the negative electrode 40 and the separator 50. The powder layer 70 is a layer (a so-called fine powder layer) including an electrically conductive material in a powder form (electrically conductive particles). The electrically conductive material includes a lithium alloy, a carbon material, or both. Specific examples of the lithium alloy include a lithium-aluminum alloy. Specific examples of the carbon material include one or more of materials including, without limitation, graphite and carbon black. Examples of the carbon black include furnace black, channel black, acetylene black, and thermal black.

In a case of using a lithium-aluminum alloy as the electrically conductive material, an aluminum foil is attached to a surface of the negative electrode 40 including the lithium-based material. Thus, in the course of aging or discharging of the primary battery, the aluminum foil is powdered, and the aluminum foil reacts with the lithium-based material. As a result, the powder layer 70 including the lithium-aluminum alloy is formed.

Note that, in a case of using a lithium-aluminum alloy as the electrically conductive material in a process of forming the powder layer 70, another formation method different from the above-described formation method may be used depending on a composition of the lithium-aluminum alloy, as will be described later. The other formation method will be described in detail later.

In a case of using the carbon material as the electrically conductive material, the carbon material is pressure-bonded to the surface of the negative electrode 40 including the lithium-based material, by one or more of pressure-bonding methods including, without limitation, compression bonding and ultrasonic bonding. Alternatively, the carbon material is dispersed in a dissolved substance of the lithium-based material. In this manner, the powder layer 70 including the carbon material is formed. Note that another method (a known method) other than the above-described two methods may be used to form the powder layer 70. In a case of using a pressure-bonding method, it is preferable to use compression bonding in terms of ease of manufacturing.

FIG. 2 illustrates a case where the powder layer 70 has an outer edge positioned on an inner side relative to an outer edge of the negative electrode 40. However, the outer edge of the powder layer 70 may be positioned on an outer side relative to the outer edge of the negative electrode 40.

In this case also, the positive electrode 30 and the negative electrode 40 are separated from each other with the separator 50 interposed therebetween. Accordingly, it is possible to achieve similar effects. In this case, in particular, electric resistance of the primary battery decreases, which allows for further improvement in the electrical characteristic such as the battery capacity. Accordingly, it is possible to achieve higher effects.

The powder layer 70 preferably includes a lithium-aluminum alloy, in particular, as the lithium alloy. A reason for this is that the electric resistance of the primary battery sufficiently decreases, which sufficiently improves the electrical characteristic such as the battery capacity. Specific examples of the lithium-aluminum alloy include LiAl, Li₃Al₂, Li₉Al₄, Li₃Al, Li₁₀Al₉₀, and Li₅Al₉₅.

The composition of the lithium-aluminum alloy is not particularly limited, and the lithium-aluminum alloy preferably has a composition represented by Formula (3), in particular. A reason for this is that the electrical characteristic such as the battery capacity improves, while the swelling characteristic is secured. As is apparent from Formula (3), m/n is a parameter that determines the composition of the lithium-aluminum alloy, and a value of m/n is rounded off to two decimal places.

LiₘAlₙ (3)

where m and n satisfy m>0, n>0, and 1.00≤(m/n)≤2.25.

Specific examples of the lithium-aluminum alloy having the composition indicated in Formula (3) include LiAl, Li₃Al₂, and Li₉Al₄.

A weight of aluminum included in the powder layer 70 is not particularly limited, and is preferably within a predetermined range with respect to respective weights of the negative electrode 40 and the powder layer 70, in particular. Specifically, a ratio W1/W2 between a weight W1 of aluminum included in the powder layer 70 and a sum W2 of the weight of the negative electrode 40 and the weight of the powder layer 70 is preferably within a range from 0.08 to 0.50 both inclusive. The ratio W1/W2 is a ratio of the weight W1 to the sum W2, and is thus calculated based on the following calculation expression: ratio W1/W2=weight W1/sum W2. Note that a value of the ratio W1/W2 is rounded off to two decimal places.

A reason why the ratio W1/W2 is within the above-described range is that an amount of aluminum is made appropriate with respect to the respective weights of the negative electrode 40 and the powder layer 70, which increases the discharge capacity.

A procedure of calculating the ratio W1/W2 is as described below. First, the primary battery is disassembled to thereby collect the negative electrode container 12 containing the negative electrode 40, the powder layer 70, and the electrolytic solution (hereinafter simply referred to as the “negative electrode container 12”). Thereafter, the negative electrode container 12 is washed with a washing solvent to thereby wash away the electrolytic solution attached to the negative electrode 40, following which a weight WC of the negative electrode container 12 is measured. The weight WC is a sum of a weight of the negative electrode container 12, the weight of the negative electrode 40, and the weight of the powder layer 70, as described above. Details of the washing solvent are as described above.

Thereafter, the negative electrode container 12 is put into pure water. Thus, lithium components included in the negative electrode container 12 react with pure water, and the lithium components are thereby dissolved and removed. The lithium components are the lithium-based material included in the negative electrode 40 and the lithium-aluminum alloy included in the powder layer 70. Accordingly, the above-described reaction with pure water is used to dissolve and remove the negative electrode 40 and the powder layer 70 from the negative electrode container 12.

Thereafter, the washed negative electrode container 12 is dried, and a weight WD of the dried negative electrode container 12 is measured, following which the weight WD is subtracted from the weight WC to thereby calculate the sum W2 of the weight of the negative electrode 40 and the weight of the powder layer 70.

Thereafter, an aqueous solution obtained by the above-described dissolving and removing process is collected. The aqueous solution includes a dissolved substance of the lithium-based material and a dissolved substance of the lithium-aluminum alloy, as described above, and thus includes unreacted aluminum. Thereafter, aqua regia is added to the aqueous solution to thereby dissolve unreacted aluminum.

Thereafter, the aqueous solution is diluted on an as-needed basis, following which the aqueous solution is analyzed by inductively coupled plasma (ICP) optical emission spectroscopy to thereby measure a concentration (g/1=g/dm³) of aluminum included in the aqueous solution. In this case, for example, PS3500DDII, a high-resolution ICP optical emission spectrometer available from Hitachi High-Tech Science Corporation is usable as an analyzer.

Lastly, the concentration of aluminum is multiplied by a volume (1=dm³) of the aqueous solution to thereby calculate the weight W1 of aluminum included in the powder layer 70, following which the ratio W1/W2 is calculated based on respective calculation results of the weights W1 and W2.

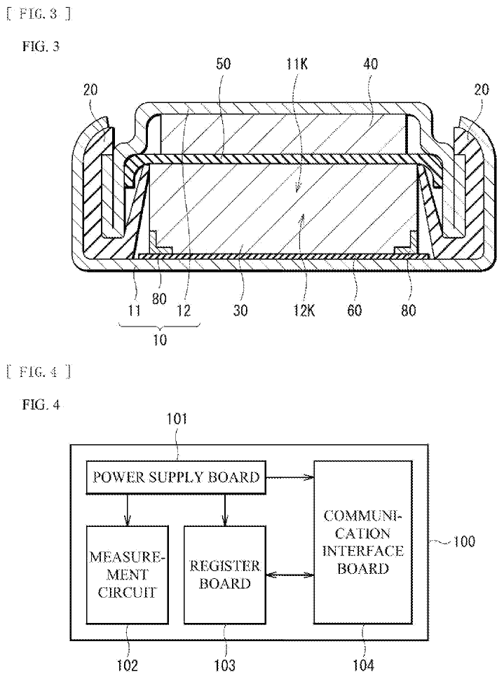

As illustrated in FIG. 3 corresponding to FIG. 1, the primary battery may further include a positive electrode ring 80.

The positive electrode ring 80 is a ring-shaped member that contains the positive electrode 30, and is disposed between the positive electrode 30 and the electrically conductive layer 60. That is, the positive electrode ring 80 has a substantially-bowl-like three-dimensional shape with an open end part and an end part partially having an opening. In a state of being contained by the positive electrode ring 80, the positive electrode 30 is adjacent to the electrically conductive layer 60 through the opening provided in the positive electrode ring 80.

The positive electrode ring 80 includes a metal material such as stainless steel. Details of the stainless steel are as described above. The positive electrode ring 80 may be fixed or welded to the inner bottom surface of the positive electrode container 11.

FIG. 3 illustrates a case where the electrically conductive layer 60 has an outer edge positioned on an outer side relative to an outer edge of the positive electrode ring 80. However, the outer edge of the electrically conductive layer 60 may be positioned on an inner side relative to the outer edge of the positive electrode ring 80.

In this case also, because the positive electrode 30 is adjacent to the electrically conductive layer 60 with the positive electrode ring 80 interposed therebetween, the positive electrode 30 is electrically coupled to the positive electrode container 11 via the electrically conductive layer 60. Accordingly, it is possible to achieve similar effects. In this case, in particular, it becomes easier to maintain an electrical coupling state between the positive electrode 30 and the positive electrode container 11 upon discharging, which makes it possible to suppress a decrease in a so-called current collection effect.

The primary battery is applicable to various applications. The applications of the primary battery are not particularly limited and may be selected as desired.

Here, a description is given of a case where the primary battery is applied to low power wide area (LPWA) communication equipment which is an example of communication equipment.

FIG. 4 illustrates a block configuration of a smart meter 100 which is an example of the LPWA communication equipment. The smart meter 100 includes a power supply board 101, a measurement circuit 102, a register board 103, and a communication interface board 104, as illustrated in FIG. 4.

The power supply board 101 includes the above-described primary battery, and supplies electric power to each of the measurement circuit 102, the register board 103, and the communication interface board 104. The measurement circuit 102 digitally measures power consumption. The register board 103 includes components including, without limitation, a microcontroller and a memory, and executes, for example, software and a security algorithm in order to perform an operation such as pricing. The smart meter 100 is thus able to implement various functions which are difficult to implement by an analog smart meter.

The communication interface board 104 transmits information such as an amount of power consumption to, for example, an electric power company, a relay apparatus, and a base station, by means of a LPWA communication system. Thus, unlike an analog smart meter, the smart meter 100 makes it possible to automate meter reading of, for example, the power consumption by performing communication via the communication interface board 104.

According to the smart meter 100, because the power supply board 101 includes the above-described primary battery, it is possible to improve the swelling characteristic of the smart meter 100 using the LPWA communication system.

### EXAMPLES

Examples of the present technology will be described according to an embodiment.

### Examples 1-1 to 1-12 and Comparative Examples 1-1 to 1-8

Primary batteries were manufactured, and thereafter the primary batteries were evaluated for their respective battery characteristics.

### [Manufacturing of Primary Battery]

The primary batteries illustrated in FIG. 1 were manufactured in accordance with the following procedure.

### (Fabrication of Positive Electrode)

First, the positive electrode active material (manganese dioxide (MnO₂)), the positive electrode binder (polytetrafluoroethylene), and the positive electrode conductor (natural graphite which was the carbon material) were mixed with each other to thereby obtain a positive electrode mixture. In this case, β-MnO₂ was used as manganese dioxide, and the mixture ratio (the weight ratio) between the positive electrode active material, the positive electrode binder, and the positive electrode conductor was set to 90:2:8. Thereafter, the positive electrode mixture was put into an aqueous solvent (pure water), following which the aqueous solvent was stirred to thereby prepare a positive electrode mixture dispersion. Thereafter, the positive electrode mixture dispersion was heated (at a heating temperature of 180° C.) to thereby dry the positive electrode mixture dispersion. Lastly, the dried positive electrode mixture was pressure-molded by means of a tablet press. In this manner, the positive electrode 30 having a pellet shape and having an outer diameter of 14.0 mm, a thickness of 1.82 mm, and a volume density of 2.90 g/cm³ was fabricated.

### (Formation of Electrically Conductive Layer)

A carbon paste was applied on the inner bottom surface of the positive electrode container 11 (SUS430 plated with nickel), following which the carbon paste was dried. The electrically conductive layer 60 including a carbon material was thereby formed.

### (Fabrication of Negative Electrode)

The lithium-based material (a lithium metal foil (Li) having an outer diameter of 16.5 mm and a thickness of 0.84 mm) was attached, while being press-molded, to an inner bottom surface of the negative electrode container 12 (SUS430 plated with nickel). In this manner, the negative electrode 40 including a simple substance of lithium was fabricated.

### (Preparation of Electrolytic Solution)

The electrolyte salt (lithium perchlorate (LiClO₄)) was added to the solvent (the cyclic carbonic acid ester and the dialkoxyalkane), and the solvent was stirred. Thereafter, the alkali metal compound and the dicarboxylic anhydride compound were added to the solvent, and the solvent was stirred.

Propylene carbonate (PC) was used as the cyclic carbonic acid ester, and 1,2-dimethoxyethane (DME) was used as the dialkoxyalkane. In this case, the mixture ratio between the cyclic carbonic acid ester and the dialkoxyalkane was set to 2.00. The content (wt %) of the electrolyte salt in the electrolytic solution was as indicated in Table 1.

As the alkali metal compound, lithium bis(fluorosulfonyl)imide (LiFSI), lithium bis(trifluoromethanesulfonyl)imide (LiTFSI), and lithium bis(pentafluoroethanesulfonyl)imide (LiBETI) were used. The content (wt %) of the alkali metal compound in the electrolytic solution was as indicated in Table 1.

As the dicarboxylic anhydride compound, pyromellitic anhydride (PMDA) and mellitic anhydride (TMA) were used. The content (wt %) of the dicarboxylic anhydride compound in the electrolytic solution was as indicated in Table 1.

In this manner, the electrolytic solution including the alkali metal compound and the dicarboxylic anhydride compound was prepared.

For comparison, the electrolytic solution was prepared by a similar procedure except that the alkali metal compound, the dicarboxylic anhydride compound, or both were not used, as indicated in Table 2.

In addition, for comparison, the electrolytic solution was prepared by a similar procedure except that another alkali metal compound was used instead of the alkali metal compound, and the electrolytic solution was prepared by a similar procedure except that another dicarboxylic anhydride compound was used instead of the dicarboxylic anhydride compound, as indicated in Table 2. As the other alkali metal compound, lithium bis(trimethylsilyl)amide (LiSA) was used. As the other dicarboxylic anhydride compound, glutaric anhydride (GA), phthalic anhydride (PA), malonic anhydride (MLOA), and maleic anhydride (MLEA) were used.

### (Assembly of Primary Battery)

First, the separator 50 (a nonwoven fabric having a thickness of 190 μm) was placed on the negative electrode 40 formed on the inner bottom surface of the negative electrode container 12, following which the gasket 20 (polyphenylene sulfide having a thickness of 0.37 mm) was placed on the separator 50. Thereafter, the electrolytic solution was dropped into the negative electrode container 12 from above the gasket 20, following which the positive electrode 30 was placed on the gasket 20. The positive electrode 30, the negative electrode 40, and the separator 50 were thereby each impregnated with a portion of the electrolytic solution. Lastly, the positive electrode container 11 was placed on the positive electrode 30, following which the positive electrode container 11 and the negative electrode container 12 were crimped to each other by means of a crimper. In this manner, the battery can 10 was formed, and the components including, without limitation, the positive electrode 30, the negative electrode 40, and the separator 50 were sealed in the battery can 10. As a result, the primary battery (having an outer diameter of 20 mm and a thickness of 3.2 mm) was completed.

### [Evaluation of Battery Characteristic]

The primary batteries were evaluated for their respective battery characteristics (the swelling characteristic and the electric resistance characteristic), which revealed the results presented in Tables 1 and 2.

### (Swelling Characteristic)

First, a thickness (a pre-storage thickness (mm)) of the primary battery was measured in an ambient temperature environment (at a temperature of 23° C.). In this case, a thickness of a middle part of the battery can 10 was measured. Thereafter, the primary battery was stored in a high-temperature environment (at a temperature of 140° C.) for a storage time of 72 hours, following which the primary battery was cooled in the ambient temperature environment. Thereafter, the primary battery was discharged with a current of 10 mA for 0.5 seconds, following which the thickness (a post-storage thickness (mm)) of the primary battery was measured. Lastly, an amount of swelling which was an index for evaluating the swelling characteristic was calculated based on the following calculation expression: amount of swelling (mm)=post-storage thickness−pre-storage thickness.

### (Electric Resistance Characteristic)

First, the primary battery was stored in a thermostatic chamber (at a temperature of 140° C.) for a storage time of 72 hours. Thereafter, the primary battery was taken out of the thermostatic chamber, following which the primary battery was left to stand to be cooled in a low-temperature environment (at a temperature of −40° C.) until its temperature became equal to the environmental temperature (=−40° C.). Lastly, at a time when the temperature of the primary battery reached the environmental temperature, a voltage (V) immediately after a current of 10 mA was supplied to the primary battery for 0.5 seconds was measured. The closed circuit voltage (CCV) which was an index for evaluating the electric resistance characteristic was thereby obtained.

TABLE 1

| | Positive | | | | | | | | | | | |
|---|---|---|---|---|---|---|---|---|---|---|---|---|
| | electrode | | Electrolytic solution | | | | | | | | | |
| | Positive | | | | | | Alkali metal | | Dicarboxylic | | Amount | |
| | electrode | | Solvent | | Electrolyte salt | | compound | | anhydride compound | | of | |
| | active | Negative | | Mixture | | Content | | Content | | Content | swelling | CCV |
| | material | electrode | Kind | ratio | Kind | (wt %) | Kind | (wt %) | Kind | (wt %) | (mm) | (V) |
| Example 1-1 | MnO₂ | Li | PC + | 2.00 | LiClO₄ | 4 | LiFSI | 0.5 | PMDA | 2.0 | 0.61 | 1.15 |
| Example 1-2 | | | DME | | | | | 1.0 | | | 0.41 | 1.70 |
| Example 1-3 | | | | | | | | 12.0 | | | 0.21 | 1.86 |
| Example 1-4 | | | | | | | | 22.0 | | | 0.17 | 1.71 |
| Example 1-5 | | | | | | | | 25.0 | | | 0.16 | 1.51 |
| Example 1-6 | | | | | | | LiTFSI | 12.0 | | | 0.45 | 1.52 |
| Example 1-7 | | | | | | | LiBETI | 12.0 | | | 0.65 | 1.13 |
| Example 1-8 | | | | | | | LiFSI | 12.0 | PMDA | 0.05 | 0.81 | 1.01 |
| Example 1-9 | | | | | | | | | | 0.1 | 0.71 | 1.01 |
| Example 1-10 | | | | | | | | | | 5.0 | 0.12 | 1.21 |
| Example 1-11 | | | | | | | | | | 8.0 | 0.13 | 1.01 |
| Example 1-12 | | | | | | | | | TMA | 2.0 | 0.21 | 1.73 |

TABLE 2

| | Positive | | | | | | | | | | | |
|---|---|---|---|---|---|---|---|---|---|---|---|---|
| | electrode | | Electrolytic solution | | | | | | | | | |
| | Positive | | | | | | Alkali metal | | Dicarboxylic | | Amount | |
| | electrode | | Solvent | | Electrolyte salt | | compound | | anhydride compound | | of | |
| | active | Negative | | Mixture | | Content | | Content | | Content | swelling | CCV |
| | material | electrode | Kind | ratio | Kind | (wt %) | Kind | (wt %) | Kind | (wt %) | (mm) | (V) |
| Comparative | MnO₂ | Li | PC + | 2.00 | LiClO₄ | 4 | — | — | — | — | 1.51 | 0.02 |
| example 1-1 | | | DME | | | | | | | | | |
| Comparative | | | | | | | LiFSI | 12.0 | — | — | 1.03 | 0.12 |
| example 1-2 | | | | | | | | | | | | |
| Comparative | | | | | | | — | — | PMDA | 2.0 | 1.02 | 0.21 |
| example 1-3 | | | | | | | | | | | | |
| Comparative | | | | | | | LiSA | 12.0 | PMDA | 2.0 | 1.42 | 0.01 |
| example 1-4 | | | | | | | | | | | | |
| Comparative | | | | | | | LiFSI | 12.0 | GA | 2.0 | 1.21 | 0.31 |
| example 1-5 | | | | | | | | | | | | |
| Comparative | | | | | | | | | PA | 2.0 | 0.81 | 0.11 |
| example 1-6 | | | | | | | | | | | | |
| Comparative | | | | | | | | | MLOA | 2.0 | 1.11 | 0.49 |
| example 1-7 | | | | | | | | | | | | |
| Comparative | | | | | | | | | MLEA | 2.0 | 1.15 | 0.41 |
| example 1-8 | | | | | | | | | | | | |

As indicated in Tables 1 and 2, the amount of swelling of the primary battery in which the positive electrode 30 included manganese dioxide and the negative electrode 40 included the lithium-based material varied greatly depending on a composition of the electrolytic solution. The following comparisons were made to the amount of swelling in a case where the electrolytic solution included neither the alkali metal compound nor the dicarboxylic anhydride compound (Comparative example 1-1).

In a case where the electrolytic solution included only either the alkali metal compound or the dicarboxylic anhydride compound (Comparative examples 1-2 and 1-3), the amount of swelling decreased slightly. In a case where the electrolytic solution included the other alkali metal compound (Comparative example 1-4), the amount of swelling decreased extremely slightly. In a case where the electrolytic solution included the other dicarboxylic anhydride compound (Comparative examples 1-5 to 1-8), the amount of swelling decreased slightly.

In contrast, in a case where the electrolytic solution included both the alkali metal compound and the dicarboxylic anhydride compound (Examples 1-1 to 1-12), the amount of swelling decreased markedly. In this case, in particular, a series of tendencies described below were obtained.

Firstly, the amount of swelling decreased even if the kind of the alkali metal compound and the kind of the dicarboxylic anhydride compound were each changed.

Secondly, if the electrolytic solution included both the alkali metal compound and the dicarboxylic anhydride compound, the amount of swelling decreased markedly, and moreover, the CCV increased markedly. In this case, if the content of the alkali metal compound in the electrolytic solution was within a range from 1.0 wt % to 22.0 wt % both inclusive, the amount of swelling further decreased and the CCV further increased.

Thirdly, if the content of the dicarboxylic anhydride compound in the electrolytic solution was within a range from 0.1 wt % to 5.0 wt % both inclusive, the amount of swelling further decreased while a high CCV was maintained.

### Examples 2-1 to 2-6

As indicated in Table 3, primary batteries were fabricated by a procedure similar to that for Example 1-3 except that the solvent was changed in kind and mixture ratio, following which the primary batteries were evaluated for their battery characteristics.

As the solvent, butylene carbonate (BC) which was the cyclic carbonic acid ester, and 1,2-diethoxyethane (DEE) which was the dialkoxyalkane were newly used. To change the mixture ratio, the mixture ratio (the weight ratio) between the cyclic carbonic acid ester and the dialkoxyalkane was changed.

TABLE 3

| | Positive | | | | | | | | | | | |
|---|---|---|---|---|---|---|---|---|---|---|---|---|
| | electrode | | Electrolytic solution | | | | | | | | | |
| | Positive | | | | | | Alkali metal | | Dicarboxylic | | Amount | |
| | electrode | | Solvent | | Electrolyte salt | | compound | | anhydride compound | | of | |
| | active | Negative | | Mixture | | Content | | Content | | Content | swelling | CCV |
| | material | electrode | Kind | ratio | Kind | (wt %) | Kind | (wt %) | Kind | (wt %) | (mm) | (V) |
| Example 2-1 | MnO₂ | Li | PC + | 0.05 | LiClO₄ | 4 | LiFSI | 12.0 | PMDA | 2.0 | 0.73 | 0.91 |
| Example 2-2 | | | DME | 0.10 | | | | | | | 0.52 | 1.21 |
| Example 1-3 | | | | 2.00 | | | | | | | 0.21 | 1.86 |
| Example 2-3 | | | | 7.00 | | | | | | | 0.32 | 1.31 |
| Example 2-4 | | | | 10.00 | | | | | | | 0.32 | 0.91 |
| Example 2-5 | | | BC + | 2.00 | | | | | | | 0.35 | 1.61 |
| | | | DME | | | | | | | | | |
| Example 2-6 | | | PC + | 2.00 | | | | | | | 0.71 | 1.33 |
| | | | DEE | | | | | | | | | |

As indicated in Table 3, the amount of swelling decreased markedly even if the solvent was changed in kind and mixture ratio (Examples 1-3 and 2-1 to 2-6). In this case, in particular, if the mixture ratio was within a range from 0.10 to 7.00 both inclusive (Examples 1-3, 2-2, and 2-3), the amount of swelling further decreased and the CCV further increased.

### Examples 3-1 to 3-5

As indicated in Table 4, primary batteries were fabricated by a procedure similar to that for Example 1-3 except that the content of the electrolyte salt was changed, following which the primary batteries were evaluated for their battery characteristics.

TABLE 4

| | Positive | | | | | | | | | | | |
|---|---|---|---|---|---|---|---|---|---|---|---|---|
| | electrode | | Electrolytic solution | | | | | | | | | |
| | Positive | | | | | | Alkali metal | | Dicarboxylic | | Amount | |
| | electrode | | Solvent | | Electrolyte salt | | compound | | anhydride compound | | of | |
| | active | Negative | | Mixture | | Content | | Content | | Content | swelling | CCV |
| | material | electrode | Kind | ratio | Kind | (wt %) | Kind | (wt %) | Kind | (wt %) | (mm) | (V) |
| Example 3-1 | MnO₂ | Li | PC + DME | 2.00 | LiClO₄ | 0 | LiFSI | 12.0 | PMDA | 2.0 | 0.17 | 0.01 |
| Example 3-2 | | | | | | 1 | | | | | 0.22 | 1.90 |
| Example 1-3 | | | | | | 4 | | | | | 0.21 | 1.86 |
| Example 3-3 | | | | | | 8 | | | | | 0.21 | 1.31 |
| Example 3-4 | | | | | | 12 | | | | | 0.22 | 1.01 |
| Example 3-5 | | | | | | 15 | | | | | 0.22 | 0.50 |

As indicated in Table 4, the amount of swelling decreased markedly even if the content of the electrolyte salt (lithium perchlorate) was changed (Examples 1-3 and 3-1 to 3-5). In this case, in particular, if the content of the electrolyte salt was within a range from 1 wt % to 12 wt % both inclusive (Examples 1-3 and 3-2 to 3-4), the CCV further increased while the amount of swelling decreased markedly.

### Examples 4-1 and 4-2

As indicated in Table 5, primary batteries were fabricated by a procedure similar to that for Example 1-3 except that the powder layer 70 was formed, following which the primary batteries were evaluated for their battery characteristics.

As the material (the electrically conductive material) included in the powder layer 70, a lithium-aluminum alloy (LiAl in which m/n indicated in Formula (3) was 0.08) which was the lithium alloy, and graphite (C) which was the carbon material were used. In a case of forming the powder layer 70 using the lithium-aluminum alloy, an aluminum foil was attached, while being press-molded, to the surface of the negative electrode 40 on a side opposed to the positive electrode 30. In a case of forming the powder layer 70 using the carbon material, graphite powder was compression-bonded to the surface of the negative electrode 40 on the side opposed to the positive electrode 30.

TABLE 5
Positive electrode (Positive electrode active material) = MnO₂, Negative electrode = Li

| | | | Electrolytic solution | | | | | | | | | |
|---|---|---|---|---|---|---|---|---|---|---|---|---|
| | Powder layer | | | | | | Alkali metal | | Dicarboxylic | | Amount | |
| | Presence | | Solvent | | Electrolyte salt | | compound | | anhydride compound | | of | |
| | or | | | Mixture | | Content | | Content | | Content | swelling | CCV |
| | absence | Kind | Kind | ratio | Kind | (wt %) | Kind | (wt %) | Kind | (wt %) | (mm) | (V) |
| Example 1-3 | Absent | — | PC + | 2.00 | LiClO₄ | 4 | LiFSI | 12.0 | PMDA | 2.0 | 0.21 | 1.36 |
| Example 4-1 | Present | LiAl | DME | | | | | | | | 0.17 | 2.11 |
| Example 4-2 | | C | | | | | | | | | 0.19 | 2.01 |

As indicated in Table 5, the amount of swelling decreased markedly even if the powder layer 70 was formed (Examples 4-1 and 4-2). In this case, in particular, if the powder layer 70 was used (Examples 4-1 and 4-2), the amount of swelling further decreased and the CCV further increased, as compared with a case where the powder layer 70 was not used (Example 1-3).

### Examples 5-1 to 5-13

As indicated in Table 6, primary batteries were fabricated by a procedure similar to that for Example 1-3, except that the lithium-aluminum alloy used as the material included in the powder layer 70 was changed in composition, following which the primary batteries were evaluated for their battery characteristics.

The composition of the lithium-aluminum alloy, that is, the value of m/n indicated in Formula (3) was as indicated in Table 6.

Here, six kinds of lithium-aluminum alloys were used. Specifically, Li₅Al₉₅ in which m/n was 0.05, Li₁₀Al₉₀ in which m/n was 0.11, LiAl in which m/n was 1.00, Li₃Al₂ in which m/n was 1.50, Li₉Al₄ in which m/n was 2.25, and Li₃Al in which m/n was 3.00 were used. A method of forming the powder layer 70 including LiAl was as described above.

A method of forming the powder layer 70 including each of Li₅Al₉₅, Li₁₀Al₉₀, Li₃Al₂, and Li₉Al₄ was as described below. First, aluminum powder (atomized aluminum powder #205 available from Minalco Co., Ltd.) was pressure-compacted to thereby obtain a pellet (having an outer diameter of 15 mm and a thickness of 0.5 mm). Thereafter, a battery of a coin type including a positive electrode (the pellet), a negative electrode (a lithium metal plate), and an electrolytic solution (including propylene carbonate as a solvent and 6 mass % of lithium perchlorate as an electrolyte salt) was fabricated. Thereafter, the battery was discharged with a constant current with a current density of 160 μA/cm² in a high-temperature environment (at a temperature of 150° C.). An alloy pellet (the lithium-aluminum alloy) was thereby obtained.

In this case, discharging was terminated at a time when the capacity of the battery reached a specific capacity, in accordance with a relationship between a potential and a capacity described in the following paper, to thereby adjust the composition of the alloy pellet.

A method of forming an alloy described in the following paper, namely, Journal of The Electrochemical Society, 166(16), A4034-A4040 (2019) Electrochemical Formation of Four Al—Li Phases (β-AlLi, Al₂Li₃, AlLi₂₋ₓ, Al₄Li₉) at Intermediate Temperatures; Mohammadreza Zamanzad Ghavidel, Martin R. Kupsta, Jon Le, Eliana Feygin, Andres Espitia, Michael D. Fleischauer, differed from the method of forming the alloy pellet described here in that cyclic voltammetry was used to cause alloying to proceed. However, a chemical composition of the alloy stably formed in the relationship between the potential and the capacity was constant. Here, the alloy pellet was accordingly formed as described above, by utilizing the fact that a similar alloy was formable also by constant-current discharging.

Thereafter, the alloy pellet was pulverized by means of a pulverizer to thereby obtain a pulverized material.

Lastly, the pulverized material was attached, while being press-molded, to the surface of the negative electrode 40 on the side opposed to the positive electrode 30.

A method of forming the powder layer 70 including Li₃Al was as described below. First, a lithium metal block and an aluminum block were prepared. In this case, a weight ratio between the lithium metal block and the aluminum block was adjusted in accordance with the composition of the lithium-aluminum alloy. Thereafter, the lithium metal block and the aluminum block were heated (at a heating temperature of 700° C.) to thereby obtain a molten mixture of the lithium metal block and the aluminum block, following which the molten mixture was cooled to thereby obtain an alloy block. Thereafter, the alloy block was pulverized by means of a pulverizer to thereby obtain a pulverized material. Lastly, the pulverized material was attached, while being press-molded, to the surface of the negative electrode 40 on the side opposed to the positive electrode 30.

The respective values of the ratio W1/W2 and the ratio W3/W4 were as indicated in Table 6. Here, the respective weights of the negative electrode 40 and the powder layer 70 were varied to thereby adjust the value of the ratio W1/W2 to a desired value. In addition, using a primary battery having an OCV of 3.2 V, the weight of the positive electrode 30 was varied to thereby adjust the value of the ratio W3/W4 to a desired value.

As the battery characteristic of the primary battery, a discharge characteristic was newly evaluated in addition to the swelling characteristic and the electric resistance characteristic described above. Note that, in a case of evaluating each of the swelling characteristic and the electric resistance characteristic, conditions under which the primary battery was stored was changed to a temperature of 120° C. and a storage period of 1000 hours. In a case of evaluating the discharge characteristic, the primary battery was discharged with an electric resistance of 15 kΩ until a voltage reached 0 V in an ambient temperature environment (at a temperature of 23° C.), to thereby measure the discharge capacity (mAh) which was an index for evaluating the discharge characteristic.

TABLE 6
Positive electrode (Positive electrode active
material) = MnO₂, Negative electrode = Li

| | | | | | Amount | | |
|---|---|---|---|---|---|---|---|
| | | | | | of | | Discharge |
| | Powder layer | | W1/ | W3/ | swelling | CCV | (mAh) |
| | Kind | m/m | W2 | W4 | (mm) | (V) | capacity |
| Example 1-3 | — | — | 0 | 0.24 | 0.21 | 1.28 | 210 |
| Example 5-1 | Li₅Al₉₅ | 0.05 | 0.30 | 0.24 | 0.20 | 1.28 | 209 |
| Example 5-2 | Li₁₀Al₉₀ | 0.11 | 0.30 | 0.24 | 0.20 | 1.31 | 208 |
| Example 5-3 | LiAl | 1.00 | 0.30 | 0.24 | 0.20 | 1.92 | 190 |
| Example 5-4 | Li₃Al₂ | 1.50 | 0.30 | 0.24 | 0.20 | 1.87 | 198 |
| Example 5-5 | Li₉Al₄ | 2.25 | 0.30 | 0.24 | 0.19 | 1.89 | 202 |
| Example 5-6 | LiAl | 3.00 | 0.30 | 0.24 | 0.20 | 1.28 | 204 |
| Example 4-1 | LiAl | 1.00 | 0.08 | 0.24 | 0.19 | 1.51 | 205 |
| Example 5-7 | LiAl | 1.00 | 0.20 | 0.24 | 0.21 | 1.72 | 198 |
| Example 5-8 | LiAl | 1.00 | 0.50 | 0.24 | 0.18 | 1.91 | 180 |
| Example 5-9 | LiAl | 1.00 | 0.60 | 0.24 | 0.19 | 1.91 | 174 |
| Example 5-10 | LiAl | 1.00 | 0.30 | 0.16 | 0.21 | 1.65 | 165 |
| Example 5-11 | LiAl | 1.00 | 0.30 | 0.18 | 0.21 | 2.01 | 180 |
| Example 5-12 | LiAl | 1.00 | 0.30 | 0.30 | 0.20 | 1.65 | 190 |
| Example 5-13 | LiAl | 1.00 | 0.30 | 0.33 | 0.22 | 1.43 | 190 |

As indicated in Table 6, in a case where the powder layer 70 (the lithium-aluminum alloy) was used (Examples 4-1 and 5-1 to 5-13), even if the composition of the lithium-aluminum alloy was changed, a high CCV of an equal or greater value was obtained while the amount of swelling was suppressed to an equal or less value, as compared with a case where the powder layer 70 was not used (Example 1-3).

In the case where the powder layer 70 (the lithium-aluminum alloy) was used, in particular, a series of tendencies described below were obtained.

Firstly, if m/n that determined the composition of the lithium-aluminum alloy was within a range from 1.00 to 2.25 both inclusive, a higher CCV was obtained while the amount of swelling was suppressed.

Secondly, if the ratio W1/W2 was within a range from 0.08 to 0.50 both inclusive, a higher discharge capacity was obtained, while the amount of swelling was suppressed and a high CCV was obtained.

Thirdly, if the ratio W3/W4 was within a range from 0.18 to 0.33 both inclusive, a higher discharge capacity was obtained, while the amount of swelling was suppressed and a high CCV was obtained.

Based upon the results presented in Tables 1 to 6, in a case where the positive electrode 30 included manganese dioxide, where the negative electrode 40 included the lithium-based material, and where the electrolytic solution included the alkali metal compound and the dicarboxylic anhydride compound, the amount of swelling decreased. The primary battery therefore achieved a superior swelling characteristic.

Although the present technology has been described herein with reference to one or more embodiments including Examples, the configuration of the present technology is not limited thereto, and is therefore modifiable in a variety of ways.

For example, the description has been given of a case where the primary battery has a battery structure of the coin type. However, the battery structure of the primary battery is not particularly limited, and may be of any other type, such as a button type, a cylindrical type, or a prismatic type.

The effects described herein are mere examples, and effects of the present technology are therefore not limited to those described herein. Accordingly, the present technology may achieve any other suitable effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A primary battery comprising:
a positive electrode including manganese dioxide;
a negative electrode including a lithium-based material; and
an electrolytic solution including an alkali metal compound represented by Formula (1) and a dicarboxylic anhydride compound represented by Formula (2),
MeN(CₓF₂ₓ₊₁SO₂)(C_{y}F_{2y+1}SO₂) (1)
where
Me is an alkali metal element, and
x and y are each an integer of 0 or greater,
W(—C(═O)—O—C(═O)—)_{z} (2)
where
W is a benzene-based aromatic ring from which 2z-number of hydrogen atoms are eliminated, and
z is an integer of 2 or greater.

2. The primary battery according to claim 1, wherein the alkali metal element comprises lithium.

3. The primary battery according to claim 2, wherein the alkali metal compound includes at least one of lithium bis(fluorosulfonyl)imide, lithium bis(trifluoromethanesulfonyl)imide, or lithium bis(pentafluoroethanesulfonyl)imide.

4. The primary battery according to claim 1, wherein the dicarboxylic anhydride compound includes pyromellitic anhydride, mellitic anhydride, or both.

5. The primary battery according to claim 1, wherein a content of the alkali metal compound in the electrolytic solution is greater than or equal to 1.0 weight percent and less than or equal to 22.0 weight percent.

6. The primary battery according to claim 1, wherein a content of the dicarboxylic anhydride compound in the electrolytic solution is greater than or equal to 0.1 weight percent and less than or equal to 5.0 weight percent.

7. The primary battery according to claim 1, wherein
the electrolytic solution includes a cyclic carbonic acid ester and a dialkoxyalkane,
the cyclic carbonic acid ester includes propylene carbonate, butylene carbonate, or both,
the dialkoxyalkane includes 1,2-dimethoxyethane, 1,2-diethoxyethane, or both, and
a ratio of a content of the dialkoxyalkane in the electrolytic solution to a content of the cyclic carbonic acid ester in the electrolytic solution is greater than or equal to 0.10 and less than or equal to 7.00.

8. The primary battery according to claim 1, wherein
the electrolytic solution includes an electrolyte salt,
the electrolyte salt includes lithium perchlorate, and
a content of the electrolyte salt in the electrolytic solution is greater than or equal to 1 weight percent and less than or equal to 12 weight percent.

9. The primary battery according to claim 1, further comprising:
a separator disposed between the positive electrode and the negative electrode; and
a powder layer disposed between the negative electrode and the separator and including a lithium alloy, a carbon material, or both.

10. The primary battery according to claim 9, wherein
the powder layer includes the lithium alloy, and
the lithium alloy includes a lithium-aluminum alloy.

11. The primary battery according to claim 10, wherein the lithium-aluminum alloy has a composition represented by Formula (3),
LiₘAlₙ (3)
where m and n satisfy m>0, n>0, and 1.00≤m/n≤2.25.

12. The primary battery according to claim 10, wherein a ratio of a weight of aluminum included in the powder layer to a sum of a weight of the negative electrode and a weight of the powder layer is greater than or equal to 0.08 and less than or equal to 0.50.

13. The primary battery according to claim 1, wherein a ratio of a weight of the electrolytic solution to a weight of the positive electrode is greater than or equal to 0.18 and less than or equal to 0.33.
